(19) United States
(12) Patent Application Publication
(10) Pub. No.: US 2012/0257832 A1
(43) Pub. Date: Oct. 11, 2012

(54) INFORMATION PROCESSING APPARATUS AND METHOD, PROGRAM, AND IMAGING APPARATUS

(75) Inventors: Satoshi KOBAYASHI, Tokyo (JP); Hiroshi Yamazaki, Kanagawa (JP)

(73) Assignee: Sony Corporation, Tokyo (JP)

(21) Appl. No.: 13/404,702

(22) Filed: Feb. 24, 2012

(30) Foreign Application Priority Data
Apr. 6, 2011 (JP) 2011-084501

(51) Int. Cl. G06K 9/18

(52) U.S. Cl. 382/182

(57) ABSTRACT

An information processing apparatus includes: a character recognition processing portion which performs a character recognition processing with respect to a character string region in an image; a character string information extraction portion which extracts character string information being information related to a character string from the character string in which a character is recognized by the character recognition processing portion; a display character string generation portion which generates a display character string of a character font corresponding to the character string information which is extracted by the character string information extraction portion; and a display control portion which performs control so as to display the display character string in the vicinity of the character string region in the image.

### FIELD

The present technology relates to an information processing apparatus and method, a program, and an imaging apparatus, and particularly, relates to an information processing apparatus and method, a program, and an imaging apparatus which can confirm a result of a character recognition processing.

### BACKGROUND

In the related art, a technology is suggested, which performs a character recognition processing recognizing characters of a character string included in an image and displays the result of the character recognition processing at a predetermined position on an image including the character string (for example, refer to JP-A-2000-207487 and JP-A-2004-206548).

### SUMMARY

However, in the above-described technology, a position of a character string which is included in an image and a position of the character string as the result of a character recognition processing may be separated from each other, or the character string as the result of the character recognition processing may be displayed as a typeface different to that of the character string included in the image.

Therefore, it is difficult to compare the character string included in the image and the character string as the result of the character recognition processing, and there is a concern that a user may be unaware of a misrecognized character even if the misrecognized character is included in the result of the character recognition processing.

Therefore, it is desirable to easily confirm the result of the character recognition processing.

An embodiment of the present technology is directed to an information processing apparatus including: a character recognition processing portion which performs a character recognition processing with respect to a character string region in an image; a character string information extraction portion which extracts character string information being information related to a character string from the character string in which a character is recognized by the character recognition processing portion; a display character string generation portion which generates a display character string of a character font corresponding to the character string information which is extracted by the character string information extraction portion; and a display control portion which performs control so as to display the display character string in the vicinity of the character string region in the image.

In the information processing apparatus according to the embodiment of the present technology, the character string information extraction portion may extract a character size and a character code of each character in the character string as the character string information, and the display character string generation portion may determine the character font based on the character size and generate the display character string of the character font based on the character code.

In the information processing apparatus according to the embodiment of the present technology, the character string information extraction portion may extract a position of the character string region in the image as the character string information, and the display control portion may perform control so as to display the display character string in the vicinity of the character string region in the image based on the position of the character string region.

In the information processing apparatus according to the embodiment of the present technology, the character string information extraction portion may extract an inclination of the character string region with respect to a predetermined direction of the image as the character string information, and the display control portion may perform control so as to display an image of the character string region in which an inclination is corrected when the character string region is inclined with respect to a predetermined direction of the image, and may perform control so as to display the display character string in the vicinity of the character string region in the image in which the inclination is corrected.

In the information processing apparatus according to the embodiment of the present technology, the information processing apparatus may further include a color discrimination portion which identifies color of the character string region in the image, and the display character string generation portion may generate a display character string of the character font based on the color of the character string region which is discriminated by the color discrimination portion.

In the information processing apparatus according to the embodiment of the present technology, the color discrimination portion may discriminate color of a character portion and color of a background portion other than the character portion in the character string region, and the display character string generation portion may generate a display character string of the character font based on the color of the character portion and the color of the background portion.

Another embodiment of the present technology is directed to an information processing method including: performing a character recognition processing with respect to a character string region in an image; extracting character string information being information related to a character string from the character string in which a character is recognized by the performing of the character recognition processing; generating a display character string of a character font corresponding to character string information which is extracted by the extracting of the character string information; and displaying the display character string in the vicinity of the character string region in the image.

Still another embodiment of the present technology is directed to a program which causing a computer to execute processings, the processings including: performing a character recognition processing with respect to a character string region in an image; extracting character string information being information related to a character string from the character string in which a character is recognized by the performing of the character recognition processing; generating a display character string of a character font corresponding to character string information which is extracted by the extracting of the character string information; and performing control so as to display the display character string in the vicinity of the character string region in the image.

Yet another embodiment of the present technology is directed to an imaging apparatus including: an imaging portion which images an object; a character recognition processing portion which performs a character recognition processing with respect to a character string region in a captured image obtained through the imaging by the imaging portion; a character string information extraction portion which extracts character string information being information related to a character string from the character string in which a character is recognized by the character recognition processing portion; a display character string generation portion which generates a display character string of a character font corresponding to the character string information which is extracted by the character string information extraction portion; and a display control portion which performs control so as to display the display character string in the vicinity of the character string region in the captured image.

According to the embodiment of the present technology, a character recognition processing is performed with respect to a character string region in an image, character string information being information related to a character string from the character string in which a character is recognized is extracted, a display character string of a character font corresponding to the extracted character string information is generated, and the display character string is controlled so as to be displayed in the vicinity of the character string region in the image.

According to the embodiment of the present technology, it is possible to further easily confirm the result of the character recognition processing.

### BRIEF DESCRIPTION OF THE DRAWINGS

FIG. 1 is a block diagram showing a functional configuration example of an embodiment of an imaging apparatus as an information processing apparatus to which an embodiment of the present technology is applied.

FIG. 2 is a block diagram showing a functional configuration example of a character string information extraction portion.

FIG. 3 is a block diagram showing a functional configuration example of a character string region color discrimination portion.

FIG. 4 is a block diagram showing a functional configuration example of a display character string generation portion.

FIG. 5 is a flow chart illustrating a reorganization character string display processing.

FIG. 6 is a flow chart illustrating a character string information extraction processing.

FIGS. 7A and 7B are diagrams illustrating character string information.

FIG. 8 is a diagram showing a configuration of the character string information.

FIG. 9 is a flow chart illustrating a character string region color discrimination processing.

FIG. 10 is a flowchart illustrating a display character string generation processing.

FIG. 11 is a diagram illustrating an example of the display of the display character string.

FIG. 12 is a diagram illustrating an example of the display of the display character string.

FIG. 13 is a block diagram showing a configuration example of computer hardware.

### DETAILED DESCRIPTION

Hereinafter, an embodiment of the present technology will be described with reference to the drawings. In addition, the description is performed according to the following order.

1. Functional Configuration of Imaging Apparatus

2. Reorganization Character String Display Processing

### <1. Functional Configuration of Imaging Apparatus>

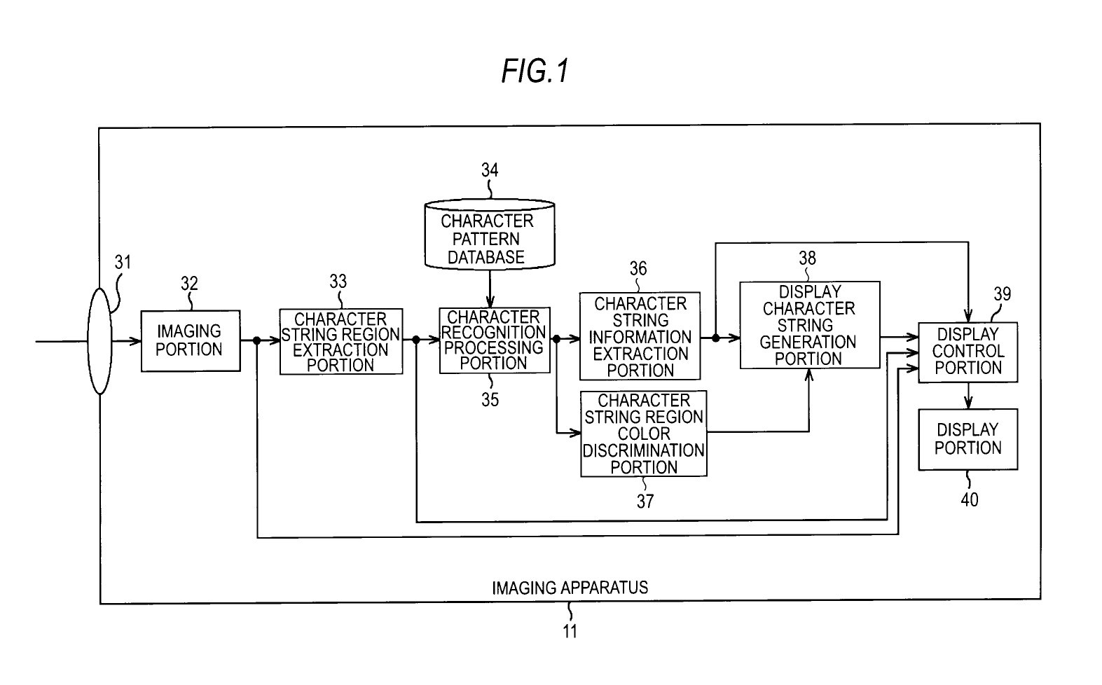

FIG. 1 shows a configuration of an embodiment of an imaging apparatus as an information processing apparatus to which the present technology is applied.

For example, an imaging apparatus 11 of FIG. 1 includes a digital still camera. The imaging apparatus images an object according to an operation of a user, and accumulates the captured image (static image) of the object or presents the image to the user. In addition, according to an operation of a user, the imaging apparatus 11 performs a character recognition processing with respect to a character string which is included in the captured image and presents the result of the character recognition processing to the user. In addition, the imaging apparatus 11 may include a digital video camera which may accumulate a moving image as the captured image of the object or may present the image to the user.

The imaging apparatus 11 of FIG. 1 includes a lens 31, an imaging portion 32, a character string region extraction portion 33, a character pattern database 34, a character recognition processing portion 35, a character string information extraction portion 36, a character string region color discrimination portion 37, a display character string generation portion 38, a display control portion 39, and a display portion 40.

The imaging portion 32 is configured so as to include an imaging device or an A/D (Analog/Digital) conversion portion. In addition, the imaging portion receives light from the lens and images an object by performing a photoelectric conversion of the light, and performs an A/D conversion of the obtained analog image signal. The imaging portion 32 supplies digital image data (hereinafter, referred to as “captured image”), which is obtained as a result of the A/D conversion, to the character string region extraction portion 33 and the display control portion 39.

The character string region extraction portion 33 extracts an image (character string region image) of a region including a character string (character string region), which is set by an operation of a user through an operation portion (not shown) when an object is imaged and becomes the subject to be recognized, from the captured image of the imaging portion 32, and supplies the extracted image to the character recognition processing portion 35 and the display control portion 39.

The character pattern database 34 stores a character pattern being a character candidate which becomes the result of the character recognition processing which is performed by the character recognition processing portion 35.

The character recognition processing portion 35 performs a character recognition processing with respect to the character string region image from the character string region extraction portion 33 by using the character pattern stored in the character pattern database 34, and supplies the result of the character recognition processing together with the character string region image to the character string information extraction portion 36 and the character string region color discrimination portion 37.

The character string information extraction portion 36 extracts character string information, which is the information related to the recognized character string, from the character string region image of the character recognition processing portion 35 based on the result of the character recognition processing from the character recognition processing portion 35, and supplies the extracted information to the display character string generation portion 38 and the display control portion 39.

The character string region color discrimination portion 37 discriminates color of the character string region based on the result of the character recognition processing from the character recognition processing portion 35 and the character string region image, and supplies character string region color information which is the information indicating the indentified color to the display character string generation portion 38.

The display character string generation portion 38 generates a display character string which is the character string of a character font corresponding to the character string information from the character string information extraction portion 36 based on the character string region color information from the character string region color discrimination portion 37, and supplies the generated character string to the display control portion 39. Here, the character font indicates a data (typeface data) which represents a typeface of the character.

The display control portion 39 controls the display of the display portion 40 so as to display the display character string from the display character string generation portion 38 in the vicinity of the character string region in the captured image from the image portion 32.

The display portion 40 displays the captured image on which the display character string is superimposed by the control of the display control portion 39.

### [Configuration of Character String Information Extraction Portion]

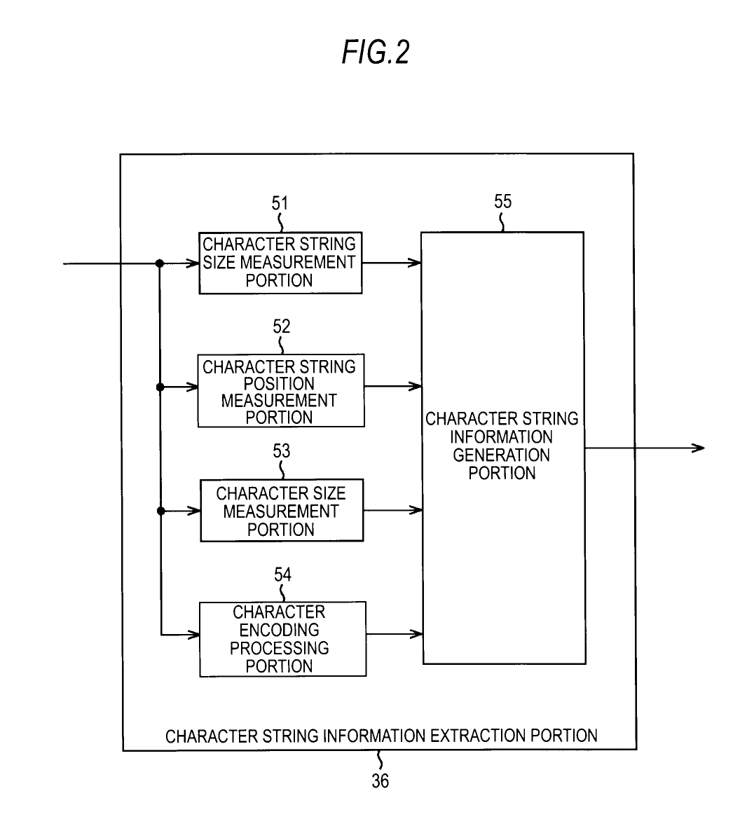

Here, a configuration of the character string information extraction portion 36 will be described with reference to FIG. 2.

The character string information extraction portion 36 of FIG. 2 includes a character string size measurement portion 51, character string position measurement portion 52, a character size measurement portion 53, a character encoding processing portion 54, and a character string information generation portion 55.

The character string size measurement portion 51 measures a size of the character string region (character string size) in the captured image based on the character string region image from the character recognition processing portion 35, and supplies the measured size to the character string information generation portion 55.

The character string position measurement portion 52 measures a position of the character string region (character string position) in the captured image based on the character string region image from the character recognition processing portion 35, and supplies the measured position to the character string information generation portion 55.

The character size measurement portion 53 measures each size (character size) of the characters of the character string in the character string region image based on the result of the character recognition processing and the character string region image from the character recognition processing portion 35, and supplies the measured sizes to the character string information generation portion 55.

The character encoding processing portion 54 converts each character of the character string in the character string region image to a predetermined character code based on the result of the character recognition processing and the character string region image from the character recognition processing portion 35, and supplies the converted code to the character string information generation portion 55.

The character string information generation portion 55 generates the character string information which has the character string size from the character string size measurement portion 51, the character string position from the character string position measurement portion 52, the character size from the character size measurement portion 53, and the character code from the character encoding processing portion 54 as the component.

### [Configuration of Character String Region Color Discrimination Portion]

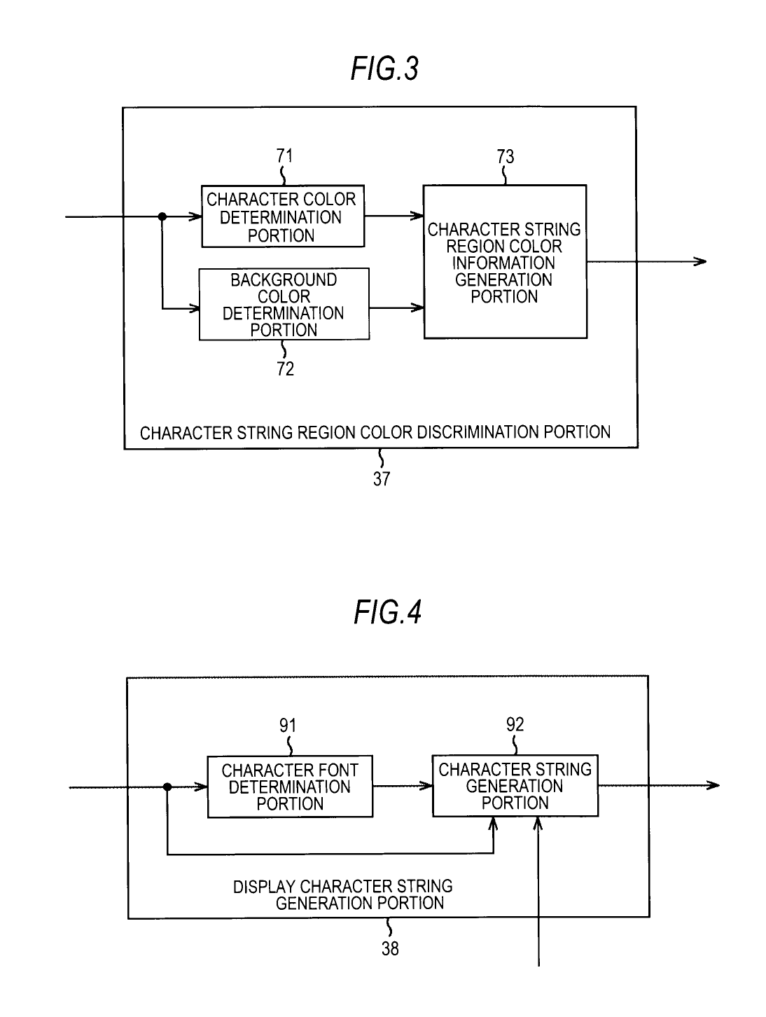

Next, a configuration of the character string region color discrimination portion 37 will be described with reference to FIG. 3.

The character string region color discrimination portion 37 of FIG. 3 includes a character color determination portion 71, a background color determination portion 72, and a character string region color information generation portion 73.

The character color determination portion 71 determines color of a character portion of the character string in the character string region based on the result of the character recognition processing and the character string region image from the character recognition processing portion 35, and supplies character color information which indicates the color of the determined character portion to the character string region color information generation portion 73.

The background color determination portion 72 determines color of a background portion other than the character portion of the character string in the character string region based on the result of the character recognition processing and the character string region image from the character recognition processing portion 35, and supplies background color information which indicates the color of the determined background portion to the character string region color information generation portion 73.

The character string region color information generation portion 73 generates character string region color information which has the character color information from the character color determination portion 71 and the background color information from the background color determination portion 72 as the component.

### [Configuration of Display Character String Generation Portion]

Next, a configuration of the display character string generation portion 38 will be described with reference to FIG. 4.

The display character string generation portion 38 of FIG. 4 includes a character font determination portion 91 and a character string generation portion 92.

The character font determination portion 91 determines the character font of the display character string based on the character string information from the character string information extraction portion 36, and supplies the determined font to the character string generation portion 92.

The character string generation portion 92 generates the display character string based on the character font from the character font determination portion 91, the character string information from the character string information extraction portion 36, and the character string region color information from the character string region color discrimination portion 37.

### <2. Reorganization Character String Display Processing>

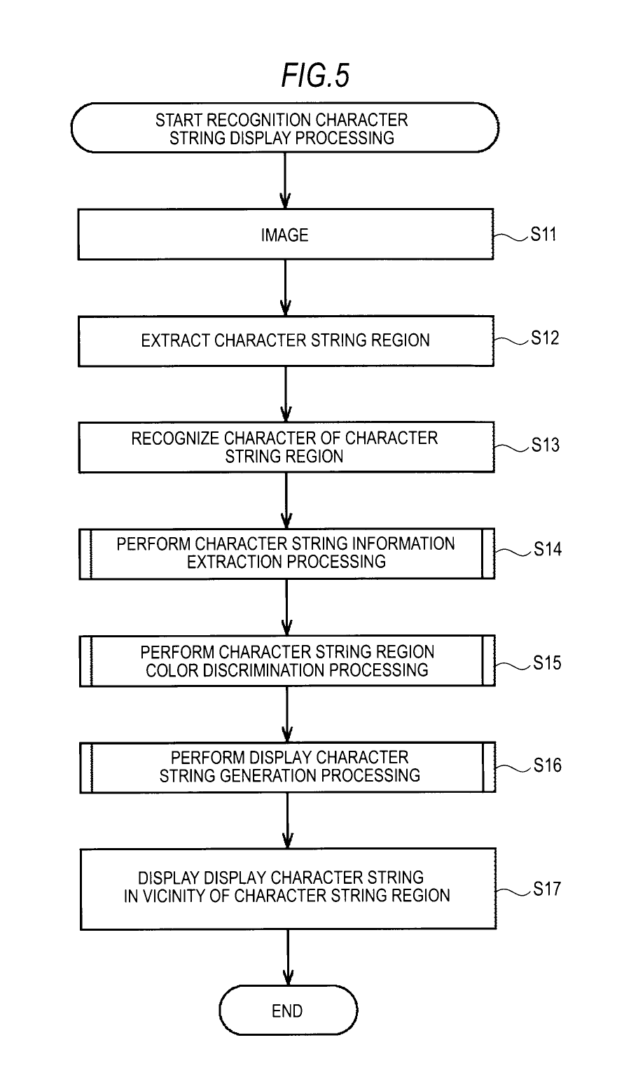

Next, a reorganization character string display processing by the imaging apparatus 11 will be described with reference to FIG. 5.

In the display portion 40 in which the operation mode of the imaging apparatus 11 is an imaging mode which images an object, a frame indicating the region set as the character string region is displayed on a through-the-lens image for confirming the object which becomes the subject to be imaged to user, for example, a shutter button (not shown) is half-pressed by the user in a state where a predetermined character string is included in the frame, and therefore, the reorganization character string display processing starts.

In a step S11, the imaging portion 32 images the object when the shutter button is half-pressed by the user, and supplies the captured image to the character string region extraction portion 33 and the display control portion 39.

In a step S12, the character string region extraction portion 33 extracts the character string region image of the character string region in the captured image from the imaging portion 32, and supplies the extracted image to the character recognition processing portion 35 and the display control portion 39.

In a step S13, the character recognition processing portion 35 performs a character recognition processing with respect to the character string region image from the character string region extraction portion 33 by using the character pattern stored in the character pattern database 34, and supplies the result of the character recognition processing together with the character string region image to the character string information extraction portion 36 and the character string region color discrimination portion 37.

In a step S14, the character string information extraction portion 36 performs a character string information extraction processing which extracts the character string information from the character string region image of the character recognition processing portion 35 based on the result of the character recognition processing from the character recognition processing portion 35.

### Example of Character String Information Extraction Processing

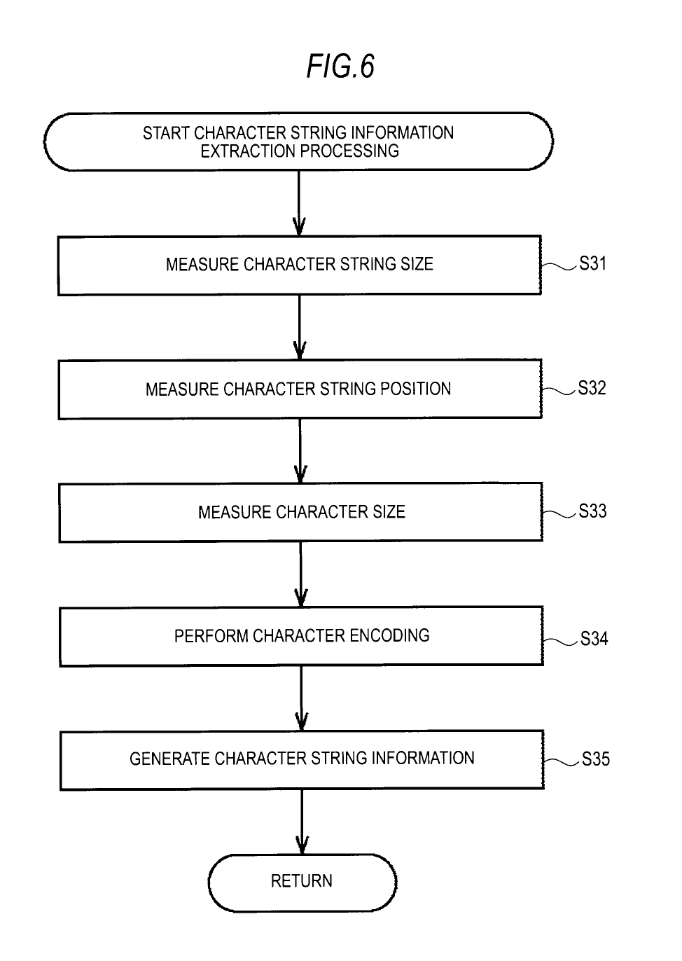

Here, the character string information extraction processing by the character string information extraction portion 36 will be described with reference to a flowchart of FIG. 6.

In a step S31, the character string size measurement portion 51 measures a height, a width, and an inclination of the character string region as the size (character string size) of the character string region in the captured image based on the character string region image from the character recognition processing portion 35, and supplies the measured sizes to the character string information generation portion 55.

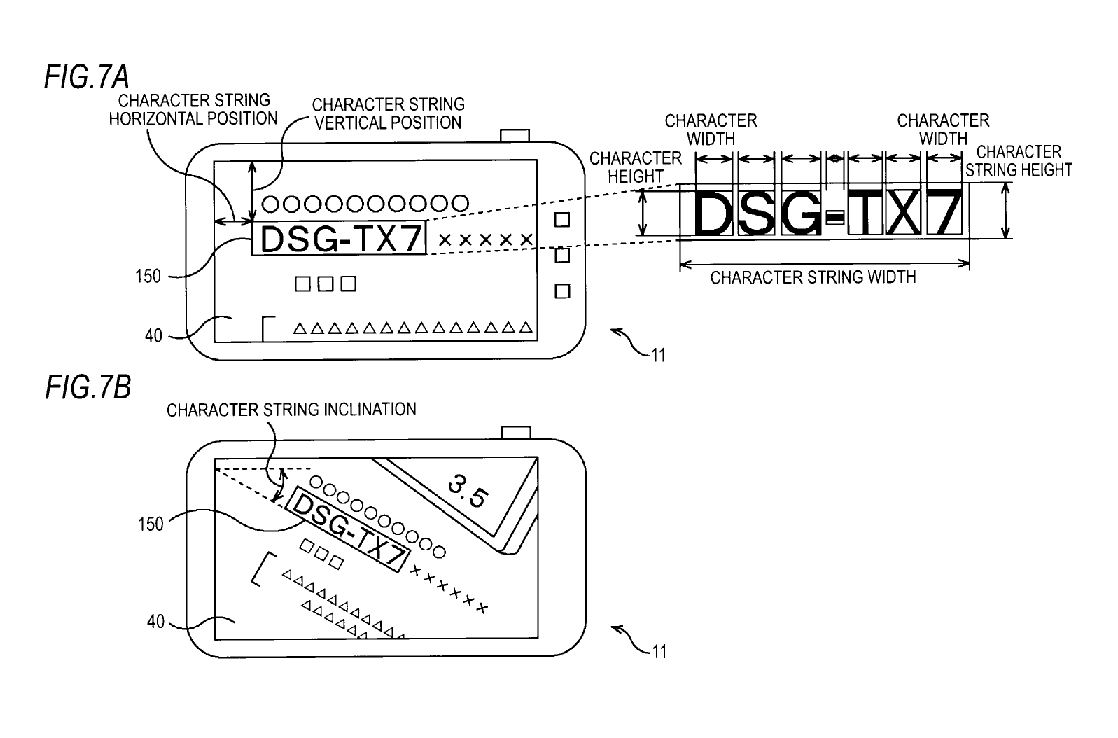

FIGS. 7A and 7B show an example of the character string region which is set to the captured image (through -the-lens image) in the display portion 40 of the imaging apparatus 11. In FIGS. 7A and 7B, a character string of “DSG-TX7” is included in the frame 150 which indicates the character string region.

That is, in the step S31, for example, as shown in FIG. 7A, the height and the width of the frame 150 indicating the character string region are measured as a height and a width of a character string region. In addition, for example, as an inclination of a character string region, as shown in FIG. 7B, the inclination of the frame 150 indicating the character string region is measured with respect to a horizontal direction of the captured image.

Next, in a step S32, as shown in FIG. 7A, the character string position measurement portion 52 measures the positions (vertical position and horizontal position) of the vertex of the upper left of the frame 150 indicating the character string region, when a vertex of the upper left of the display portion (captured image) is an origin, as the position of the character string region (character string position) in the captured image based on the character string region image from the character recognition processing portion 35, and supplies the measured positions to the character string information generation portion 55. In addition, it is preferable if the character string position specifies the position of the character string region in the captured image, and positions other than the vertex of the upper left of the frame 150 indicating the character string region may be applied.

In a step S33, the character size measurement portion 53 measures the height and the width of each character of the character string as each size (character size) of the characters of the character string in the character string region image based on the result of the character recognition processing and the character string region image from the character recognition processing portion 35, and supplies the measured sizes to the character string information generation portion 55.

That is, in the step S33, for example, as shown in the right side of FIG. 7A, the height and the width of each of the characters “D”, “S”, “G”, “-”, “T”, “X”, and “7” of the character string “DSG-TX7” which is subjected to the character recognition processing are measured.

In a step S34, based on the result of the character recognition processing and the character string region image from the character recognition processing portion 35, for example, as shown in FIGS. 7A and 7B, the character encoding processing portion 54 converts each of the characters “D”, “S”, “G”, “-”, “T”, “X”, and “7” of the character string “DSG-TX7” which is subjected to the character recognition processing to character codes such as Unicode, for example, and supplies the converted codes to the character string information generation portion 55.

In a step S35, the character string information generation portion 55 generates the character string information which has the character string size from the character string size measurement portion 51, the character string position from the character string position measurement portion 52, the character size from the character size measurement portion 53, and the character code from the character encoding processing portion 54 as the component.

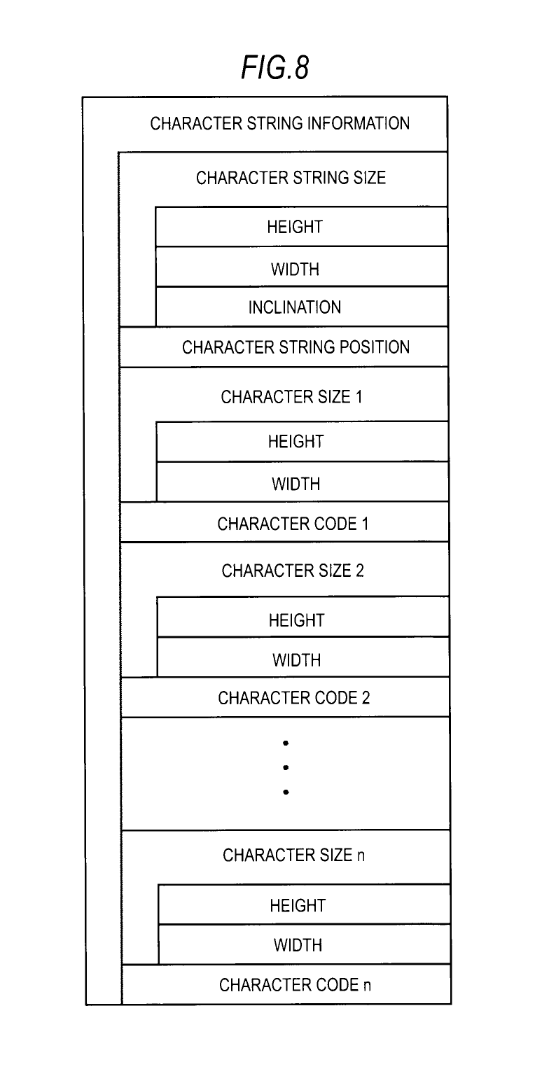

FIG. 8 shows a configuration example of the character string information which is generated by the character string information generation portion 55.

As shown in FIG. 8, the character string information includes the character string size which includes the height, the width, and the inclination of the character string, the character string position, the character size which includes the height and the width of the character, and the character code. In the character string information of FIG. 8, with respect to the character size and the character code, each of n characters which are included in the character string is present.

The character string information generated in this way is supplied to the display character string generation portion 38 and the display control portion 39, and the processing is returned to the step S14 of the flow chart of FIG. 5.

After the step S14, the processing proceeds to the step S15, and the character string region color discrimination portion 37 performs a character string region color discrimination processing based on the result of the character recognition processing from the character recognition processing portion 35 and the character string region image from the character recognition processing portion 35, and generates character string region color information.

### [Example of Character String Information Extraction Processing]

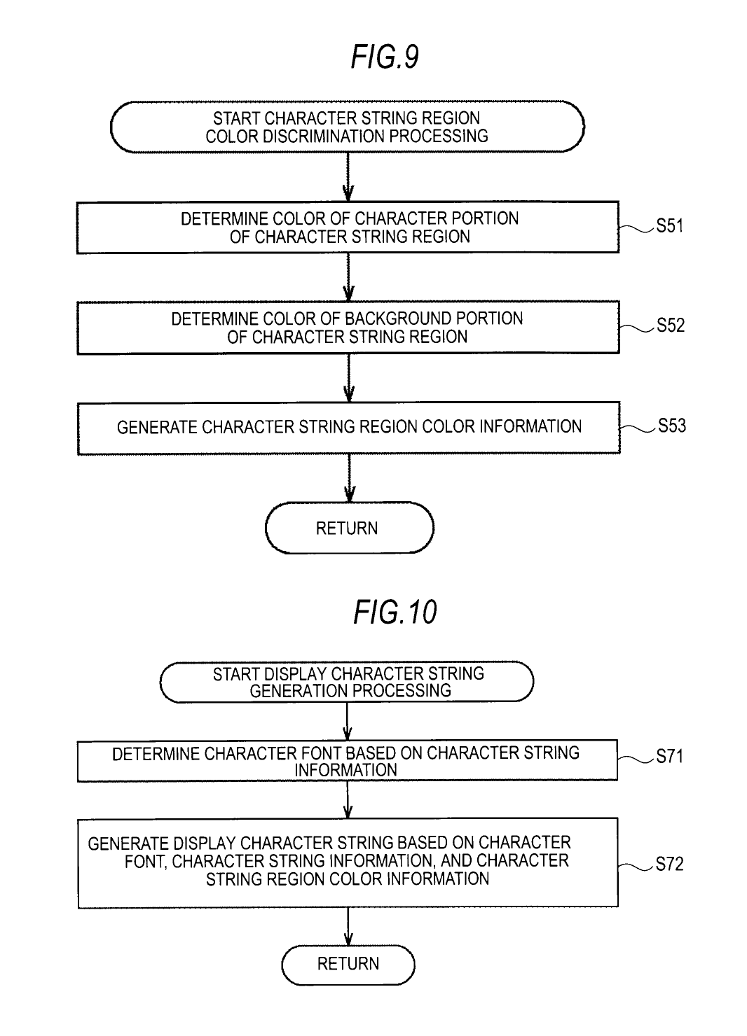

Here, a character string region color discrimination processing by the character string region color discrimination portion 37 will be described with reference to a flow chart of FIG. 9.

In a step S51, the character color determination portion 71 determines color of a character portion of the character string in the character string region based on the result of the character recognition processing and the character string region image from the character recognition processing portion 35, and supplies the character color information which indicates the color of the determined character portion to the character string region color information generation portion 73.

In a step S52, the background color determination portion 72 determines color of a background portion other than the character portion of the character string in the character string region based on the result of the character recognition processing and the character string region image from the character recognition processing portion 35, and supplies the background color information which indicates the color of the determined background portion to the character string region color information generation portion 73.

In a step S53, the character string region color information generation portion 73 generates the character string region color information which has the character color information from the character color determination portion 71 and the background color information from the background color determination portion 72 as the component.

The character string region color information generated in this way is supplied to the display character string generation portion 38, and the processing is returned to the step S15 of the flow chart of FIG. 5.

After the step S15, the processing proceeds to a step S16, and the display character string generation portion 38 performs the display character string generation processing which generates the display character string, which is the character string of the character font corresponding to the character string information from the character string information extraction portion 36, based on the character string region color information from the character string region color discrimination portion 37.

### [Example of Display Character String Generation Processing]

Here, the display character string generation processing by the display character string generation portion 38 will be described with reference to a flow chart of FIG. 10.

In a step S71, the character font determination portion 91 determines the character font of the display character string based on the character string information from the character string information extraction portion 36, and supplies the determined font to the character string generation portion 92.

Specifically, the character font determination portion 91 determines the character font which approximates to an aspect ratio of the character of the character string region and in which the heights of the characters of the character string region substantially coincide with one another based on the character size (height and width) and the character code of each character of the character string in the character string information.

In a step S72, the character string generation portion generates the display character string based on the character font from the character font determination portion 91, the character string information from the character string information extraction portion 36, and the character string region color information from the character string region color discrimination portion 37.

Specifically, the character string generation portion generates the display character string which is the character string of the character font from the character font determination portion 91 based on the character code of each character of the character string in the character string information from the character string information extraction portion 36. In addition, the character string generation portion 92 sets the display region for displaying the display character string based on the character string size (height and width) of the character string information. Moreover, the character string generation portion 92 generates the display character string image which has the character color of the display character string in the display region as the color which is represented by the character color information of the character string region color information from the character string region color discrimination portion 37, and the background color of the display character string in the display region as the color which is represented by the background color information of the character string region color information.

The display character string (display character string image) generated in this way is supplied to the display control portion 39, and the processing is returned to the step S16 of the flow chart of FIG. 5.

After the step S16, the processing proceeds to a step S17, and the display control portion 39 controls the display of the display portion 40 so as to display the display character string (display character string image) from the display character string generation portion 38 in the vicinity of the character string region in the captured image.

Specifically, the display control portion 39 controls the display of the display portion 40 so as to display the display character string image from the display character string generation portion 38 to the character string region side by side in the captured image based on the character string position of the character string information.

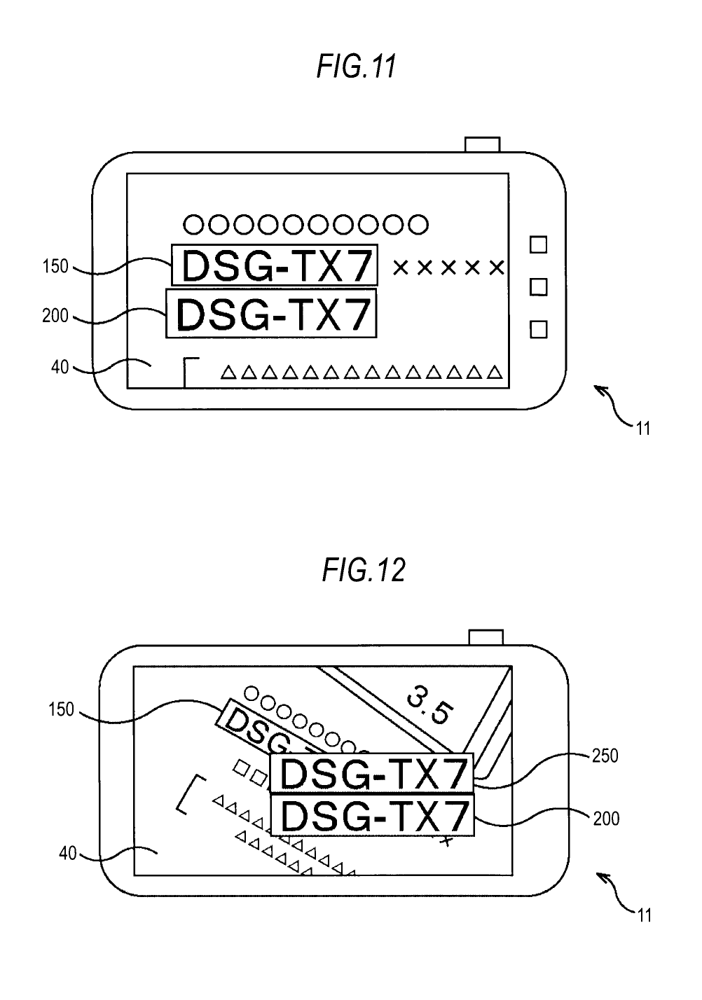

For example, as shown in FIG. 11, in the display portion 40, the display character string image 200 is disposed below the frame 150 indicating the character string region and displayed so that the positions in the horizontal direction of the initial character “D” of the character string in the frame 150 indicating the character string region in the captured image and the initial character “D” in the display character string image 200 are matched to each other.

In addition, when an inclination of the character string is present in the character string size of the character string information from the character string information extraction portion 36, that is, as illustrated in FIG. 7B, when the frame 150 indicating the character string region is inclined with respect to the horizontal direction of the captured image, the display control portion 39 controls the display of the display portion 40 so as to display the display character string (display character string image) from the display character string generation portion 38 in the vicinity of an inclination corrected character string region image in which the inclination of the character string region image from the character string region extraction portion 33 is corrected.

For example, as shown in FIG. 12, in the display portion 40, the inclination corrected character string region image 250, which corrects the inclination of the character string region image indicated by the frame 150 indicating the character string region in the captured image, is displayed in a predetermined position of the captured image. In addition, the display character string image 200 is disposed below the inclination corrected character string region image 250 and displayed so that the positions in the horizontal direction of the initial character “D” of the character string in the inclination corrected character string region image 250 and the initial character “D” in the display character string image 200 are matched to each other.

Moreover, the display character string image 200 is disposed in the frame 150 indicating the character string region or below the inclination corrected character string region image 250. However, for example, the display character string image 200 may be disposed in positions, in which the character string of the character string region and the display character string image 200 are easily compared to each other, such as the upper side of those.

According to the above-described processing, in the captured image, the character string of the character font corresponding to the size of the character of the character string in which the character is recognized is displayed in the vicinity of the character string region in which the character recognition processing is performed. Thereby, the character string which is included in the image and the character string as the result of the character recognition processing are easily compared to each other, and user can easily confirm the result of the character recognition processing. Therefore, for example, even if a misrecognized character is included in the result of the character recognition processing, the user can simply find the misrecognized character.

In addition, by making each of the color of the character portion and the color of the background portion in the display character string image be the color of the character portion of the character string region image and the color of the background portion in the captured image, the character string which is included in the image and the character string as the result of the character recognition processing are more easily compared to each other. Therefore, a user can more easily confirm the result of the character recognition processing.

Moreover, when the character string region image or the entire captured image is a black and white image or an image close thereto, in the imaging apparatus 11, the character string region color discrimination portion 37 is not provided, and the character string region color discrimination processing may not be performed.

Moreover, in those described above, the character string region is set by a user when the imaging is performed. However, a plurality of character strings included in the through-the-lens image may be recognized, and a region which includes the character string satisfying predetermined conditions among the recognized strings may be set as the character string region.

In addition, in those described above, the configuration in which the present technology is applied to the imaging apparatus including the imaging portion is described. However, the present technology is not limited to the imaging apparatus, and may be applied to an information processing apparatus which performs a predetermined processing with respect to an input image and displays.

The above-described series of processings may be performed by hardware and be performed by software. When the series of processings are performed by software, the program configuring the software is installed from a program medium to computer which is incorporated as dedicated hardware, or those capable of performing various functions by installing various programs, for example, a general-purpose personal computer.

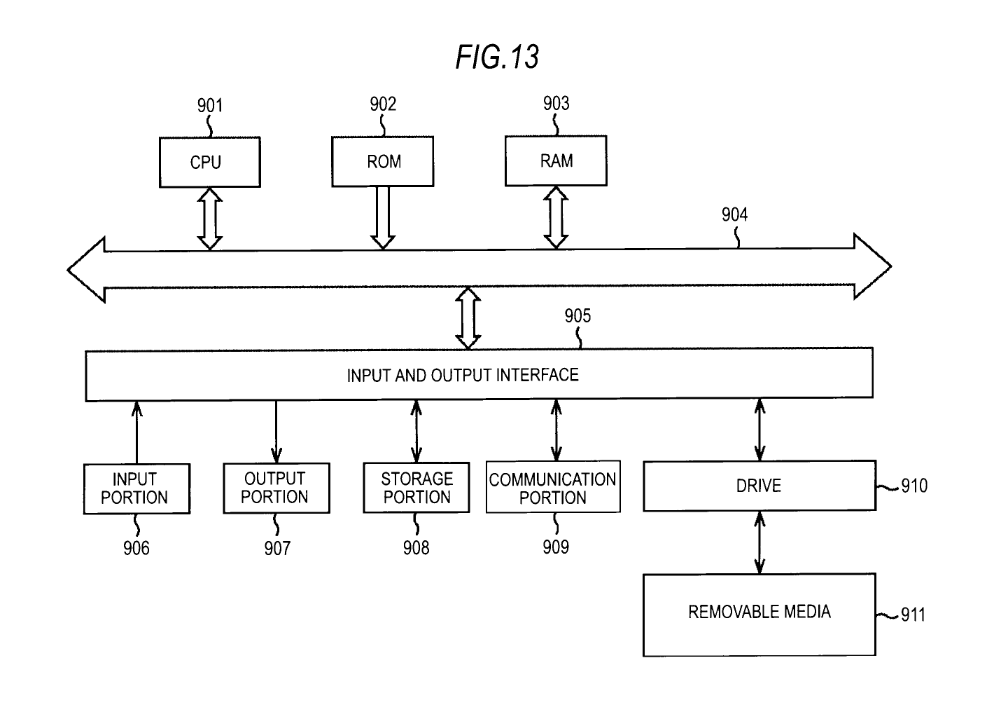

FIG. 13 is a block diagram showing a configuration example of computer hardware which performs the above-described series of processings by a program.

In the computer, a CPU (Central Processing Unit) 901, a ROM (Read Only Memory) 902, and a RAM (Random Access Memory) 903 are connected to one another by a bus 904.

In addition, an input and output interface 905 is connected to the bus 904. An input portion 906 which includes a keyboard, a mouse, a microphone, or the like; an output portion 907 which includes a display, a speaker, or the like; a storage portion 908 which includes a hard disk, non-volatile memory, or the like; a communication portion 909 which includes a network interface or the like; and a drive 910 which drives removable media 911 such as a magnetic disk, an optical disc, a magneto-optical disc, or semiconductor memory are connected to the input and output interface 905.

In the computer which is configured as above, for example, due to the fact that the CPU 901 loads the program stored in the storage portion 908 onto the RAM 903 via the input and output interface 905 and the bus 904 and performs the program, the above-described series of processings are performed.

For example, the program performed by the computer (CPU 901) is recorded on a magnetic disk (including a flexible disk), an optical disc (CD-ROM (Compact Disc-Read Only Memory), a DVD (Digital Versatile Disc), or the like), a magneto-optical disc, or removable media 911 which are package media including a semiconductor memory or the like and supplied, or is supplied via wired or wireless transmission media such as a local area network, the Internet, or digital satellite broadcasting.

Moreover, the program can be installed on the storage portion 908 via the input and output interface 905 due to the fact that the removable media 911 are mounted on the drive 910. In addition, the program is received at the communication portion 909 via wired or wireless transmission media and can be installed in the storage portion 908. Moreover, the program can be installed on the ROM 902 or the storage portion 908 in advance.

In addition, the program performed by the computer may be a program in which the processings are performed in time series according to the order described in the present specification, or may be a program in which the processings are performed in parallel, or at necessary timing such as when a call is made.

Moreover, the embodiment of the present technology is not limited to the above-described embodiments, and various modifications can be performed within a scope which does not depart from the gist of the present technology.

In addition, the present technology may be embodied as the following configurations.

(1) An information processing apparatus including: a character recognition processing portion which performs a character recognition processing with respect to a character string region in an image; a character string information extraction portion which extracts character string information being information related to a character string from the character string in which a character is recognized by the character recognition processing portion; a display character string generation portion which generates a display character string of a character font corresponding to the character string information which is extracted by the character string information extraction portion; and a display control portion which performs control so as to display the display character string in the vicinity of the character string region in the image.

(2) The information processing apparatus described in (1), wherein the character string information extraction portion extracts a character size and a character code of each character in the character string as the character string information, and the display character string generation portion determines the character font based on the character size and generate the display character string of the character font based on the character code.

(3) The information processing apparatus described in (1) or (2), wherein the character string information extraction portion extracts a position of the character string region in the image as the character string information, and the display control portion performs control so as to display the display character string in the vicinity of the character string region in the image based on the position of the character string region.

(4) The information processing apparatus described in (1) or (2), wherein the character string information extraction portion extracts an inclination of the character string region with respect to a predetermined direction of the image as the character string information, and the display control portion performs control so as to display an image of the character string region in which an inclination is corrected when the character string region is inclined with respect to a predetermined direction of the image, and performs control so as to display the display character string in the vicinity of the character string region in the image in which the inclination is corrected.

(5) The information processing apparatus described in any one of (1) to (4), wherein the information processing apparatus further includes a color discrimination portion which indentifies color of the character string region in the image, and the display character string generation portion generates a display character string of the character font based on the color of the character string region which is discriminated by the color discrimination portion.

(6) The information processing apparatus described in (5), wherein the color discrimination portion discriminates color of a character portion and color of a background portion other than the character portion in the character string region, and the display character string generation portion generates a display character string of the character font based on the color of the character portion and the color of the background portion.

(7) An information processing method including: performing a character recognition processing with respect to a character string region in an image; extracting character string information being information related to a character string from the character string in which a character is recognized by the performing of the character recognition processing; generating a display character string of a character font corresponding to character string information which is extracted by the extracting of the character string information; and displaying the display character string in the vicinity of the character string region in the image.

(8) A program causing a computer to execute processings, the processings including: performing a character recognition processing with respect to a character string region in an image; extracting character string information being information related to a character string from the character string in which a character is recognized by the performing of the character recognition processing; generating a display character string of a character font corresponding to character string information which is extracted by the extracting of the character string information; and performing control so as to display the display character string in the vicinity of the character string region in the image.

(9) An imaging apparatus including: an imaging portion which images an object; a character recognition processing portion which performs a character recognition processing with respect to a character string region in a captured image obtained through the imaging by the imaging portion; a character string information extraction portion which extracts character string information being information related to a character string from the character string in which a character is recognized by the character recognition processing portion; a display character string generation portion which generates a display character string of a character font corresponding to the character string information which is extracted by the character string information extraction portion; and a display control portion which performs control so as to display the display character string in the vicinity of the character string region in the captured image.

The present disclosure contains subject matter related to that disclosed in Japanese Priority Patent Application JP 2011-084501 filed in the Japan Patent Office on Apr. 6, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a character recognition processing portion which performs a character recognition processing with respect to a character string region in an image;
a character string information extraction portion which extracts character string information being information related to a character string from the character string in which a character is recognized by the character recognition processing portion;
a display character string generation portion which generates a display character string of a character font corresponding to the character string information which is extracted by the character string information extraction portion; and
a display control portion which performs control so as to display the display character string in the vicinity of the character string region in the image.

2. The information processing apparatus according to claim 1,
wherein the character string information extraction portion extracts a character size and a character code of each character in the character string as the character string information, and
the display character string generation portion determines the character font based on the character size and generates the display character string of the character font based on the character code.

3. The information processing apparatus according to claim 1,
wherein the character string information extraction portion extracts a position of the character string region in the image as the character string information, and
the display control portion performs control so as to display the display character string in the vicinity of the character string region in the image based on the position of the character string region.

4. The information processing apparatus according to claim 1,
wherein the character string information extraction portion extracts an inclination of the character string region with respect to a predetermined direction of the image as the character string information, and
the display control portion performs control so as to display an image of the character string region in which an inclination is corrected when the character string region is inclined with respect to a predetermined direction of the image, and performs control so as to display the display character string in the vicinity of the character string region in the image in which the inclination is corrected.

5. The information processing apparatus according to claim 1, further comprising:
a color discrimination portion which identifies color of the character string region in the image,
wherein the display character string generation portion generates a display character string of the character font based on the color of the character string region which is discriminated by the color discrimination portion.

6. The information processing apparatus according to claim 5,
wherein the color discrimination portion discriminates color of a character portion and color of a background portion other than the character portion in the character string region, and
the display character string generation portion generates a display character string of the character font based on the color of the character portion and the color of the background portion.

7. An information processing method comprising:
performing a character recognition processing with respect to a character string region in an image;
extracting character string information being information related to a character string from the character string in which a character is recognized by the performing of the character recognition processing;
generating a display character string of a character font corresponding to character string information which is extracted by the extracting of the character string information; and
displaying the display character string in the vicinity of the character string region in the image.

8. A program causing a computer to execute processings, the processings comprising:
performing a character recognition processing with respect to a character string region in an image;
extracting character string information being information related to a character string from the character string in which a character is recognized by the processing of the character recognition processing;
generating a display character string of a character font corresponding to character string information which is extracted by the extracting of the character string information; and
performing control so as to display the display character string in the vicinity of the character string region in the image.

9. An imaging apparatus comprising:
an imaging portion which images an object;
a character recognition processing portion which performs a character recognition processing with respect to a character string region in a captured image obtained through the imaging by the imaging portion;
a character string information extraction portion which extracts character string information being information related to a character string from the character string in which a character is recognized by the character recognition processing portion;
a display character string generation portion which generates a display character string of a character font corresponding to the character string information which is extracted by the character string information extraction portion; and
a display control portion which performs control so as to display the display character string in the vicinity of the character string region in the captured image.
